(19) United States
(12) Patent Application Publication
(10) Pub. No.: US 2011/0050954 A1
(43) Pub. Date: Mar. 3, 2011

(54) AUTOMATIC IMAGE FAVORITE USING GYRO

(76) Inventor: Wayne E. Prentice, Honeoye Falls, NY (US)

(21) Appl. No.: 12/546,933

(22) Filed: Aug. 25, 2009

(51) Int. Cl. H04N 5/76; H04N 5/222

(52) U.S. Cl. 348/231.2; 348/E05.031; 348/333.01; 348/E05.022

(57) ABSTRACT

The present invention takes advantage of a typical user behavior that occurs when a “favorite” image is reviewed. The holder of the display will pass the device (camera, frame, etc) to share the image. This behavior is detected using gyroscopes. The image being viewed while there is a high level of movement can then be inferred to be of higher interest than one where the camera remains static. The higher value is indicated by tagging the image as a favorite. This information is stored as metadata either in the image file or a data structure that is associated with the file.

### FIELD OF THE INVENTION

The present invention relates to classifying images and more particularly to a method for determining the interest level of images during image display. The method includes sequentially displaying a plurality of digital images for viewing by a user, and monitoring the viewing time and gyro's motion to determine a high value and or interest image (i.e., a favorite image).

### BACKGROUND OF THE INVENTION

Digital cameras are used by a growing number of consumer and professional photographers. These cameras use one or more CCD or CMOS image sensors to capture electronic representations of images that are subsequently converted to digital image files, which are then stored in digital memory of a camera. The digital image files can then be viewed, stored, retrieved, and printed using a computer, and/or they can also be uploaded to a web site for viewing.

The cost of a digitally captured image is extremely small, which is usually only the cost required for storage and the initial cost of the camera. As a result, many images can be captured and stored without regard to the value of the image. This typically results in large number of images of which only a small percentage represents the best of the collection. Many prior art methods have been used to identify the best images. For example, favorite tagging has been used at the point of capture. Identifying an image as a favorite typically includes either tagging an image as a favorite or indicating on a scale the value of the image. This process has typically been manual.

In commonly-assigned U.S. Pat. No. 5,633,678 “Electronic Still Camera for Capturing And Categorizing Images” to Parulski et al., the disclosure of which is herein incorporated by reference, the digital camera includes a user control for selecting one or more classifications to which images are to be stored prior to capture. The images are then stored according to the classification.

Also, categorizing images is disclosed in U.S. Pat. No. 7,369,164 “Using Favorite Digital Images to Organize And Identify Electronic Albums” by Parulski et al. This US Patent discloses capturing digital image and identifying one of two groups to which the particular image is to be associated. The digital images and the associated group to which it belongs are then transferred to a computer where the images are put into an electronic album.

In other prior art systems, the stored digital images can be organized later when they are transferred to the computer using appropriate software. For example, the software may enable images to be organized into categories according to the people, places, subjects or events depicted as described in a paper entitled ‘FotoFile: A consumer Multimedia Organization and Retrieval System” by Kuchinsky et al. The Kuchinsky et al. paper describes metadata attributes that are used to describe certain images, including a “favorite” attribute that is used to indicate the “best’ images in a user's collection. However, in the Kuchinsky et al. paper, the “favorite” can be selected when the images are reviewed on the PC, not when they are previewed or reviewed on a camera display.

Cameras also include image processing software for improving image quality of captured images. Additional devices are sometimes included in the camera in order to facilitate this image processing. One such device is a gyroscope. A gyroscope is a device that can measure angular acceleration and is found in digital still cameras to record camera movement only during image capture and only for the purpose of reducing image blur. Many cameras do not include gyroscopes because the additional cost does not justify the improvement in image quality.

Although the prior art systems are satisfactory, improvements are always desirable. One improvement is the automatic classification of images so that human initiation or action is not needed so that classification opportunities are less likely to be missed. It is also desirable to take advantage of camera devices that may already be in a camera and to find additional functions for these devices so that the additional cost can be justified. For example, finding additional functionality for the limited-use gyroscope would greatly enhance its probability of becoming more widespread in cameras.

### SUMMARY OF THE INVENTION

The present invention takes advantage of a typical user behavior that occurs when a “favorite” image is reviewed. The holder of the display will pass the device (camera, frame, etc) to share the image. This behavior can be detected using gyroscopes. In the present invention, the motion of the camera being passed from person to person during image display is detected. The image being viewed can then be inferred to be of higher interest than one where the rendering device or camera remains static. The higher value is indicated by tagging the image as a favorite. This information is stored as metadata either in the image file or a data structure that is associated with the file.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings, wherein:

FIG. 1 is a schematic, block diagram of a digital camera of the present invention; and

FIG. 2 is a flowchart of the present invention for illustrating the process of tagging an image as a favorite.

### DETAILED DESCRIPTION OF THE INVENTION

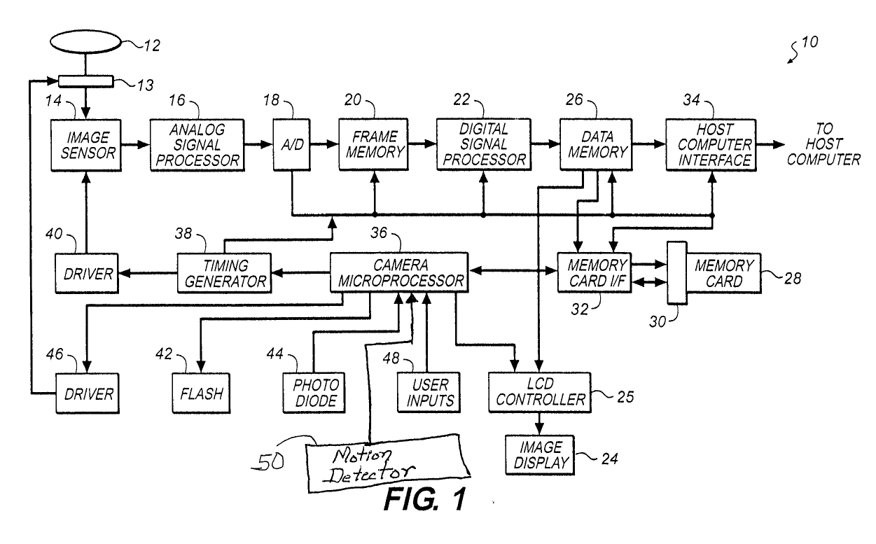

Referring to FIG. 1, a block diagram of an exemplary digital camera 10 in accordance with a first embodiment of the present invention is shown. Although a digital camera 10 is shown as the exemplary embodiment, any handheld device which displays images may be used. For example, a mobile phone, hand held picture frame or the like may be used in accordance with the present invention. As shown in FIG. 1, the digital camera 10 includes a lens 12 which directs image light from a subject (not shown) through an aperture/shutter controller 13 upon an image sensor 14 having a discrete number of photosensitive sites or pixels arranged in a two-dimensional array to form individual photosensitive sites corresponding to the pixels of the image. The image sensor 14 can be a charge-coupled device (CCD) sensor or a complementary metal oxide semiconductor (CMOS) imager, both of which are well known in the art and will not be discussed herein. The photosensitive sites of the image sensor 14 collect charge in response to incident light. Each photosensitive site is typically overlaid with a color filter array (CFA), such as the Bayer CFA described in commonly-assigned U.S. Pat. No. 3,971,065, the disclosure of which is herein incorporated by reference. The Bayer CFA has 50% green pixels in a checkerboard mosaic, with the remaining pixels alternating between red and blue rows. The photosensitive sites respond to the appropriately colored incident light illumination to provide an analog signal corresponding to the intensity of illumination incident on the photosensitive sites.

The analog output of each pixel is amplified and analog processed by an analog signal processor (ASP) 16 to reduce the image sensor's output amplifier noise. The output of the ASP 16 is converted to a digital image signal by an analog-to-digital (A/D) converter 18, such as, for example, an 8 bit A/D converter which provides an 8 bit signal in the sequence of the Bayer CFA.

The digitized image signal is temporarily stored in a frame memory 20, and is then processed and compressed by a digital signal processor (DSP) 22. The image processing typically includes white balance, color correction, tone correction, and image sharpening. The DSP 22 also decimates (or re-samples) the digitized image signal for each still image to produce a thumbnail image having fewer pixels (i.e., lower resolution) than the original captured image as described in commonly-assigned U.S. Pat. No. 5,164,831 to Kuchta et al., the disclosure of which is herein incorporated by reference. The image file containing both the full resolution image and the thumbnail image is stored in a data memory 26, and then transferred through a memory card interface 32 to a memory card 28 that is present in a memory card slot 30 of the digital camera 10. The thumbnail image is also sent to an image display 24 through an LCD controller 25 where the user can view the image. Although the display is shown as an LCD display, OLED displays may also be used. The image display 24 may, alternatively, utilize many other types of raster image displays, including miniature CRT's, organic light emitting diode (OLED) arrays, or field emission displays.

The memory card 28 can be adapted to the PCMCIA card interface standard, such as described in the PC Card Standard, Release 2.0, published by the Personal Computer Memory Card International Association, Sunnyvale, Calif., September 1991. The memory card 28 can also be adapted to the Compact Flash interface standard, such as described in the CompactFlash Specification Version 1.3, published by the CompactFlash Association, Palo Alto, Calif., Aug. 5, 1998.

Electrical connection between the memory card 28 and the digital camera 10 is maintained through a card connector (not shown) positioned in the memory card slot 30. The memory card interface 32 and the card connector provide, e.g., an interface according to the aforementioned PCMCIA card or CompactFlash interface standard. The image file may also be sent to a host computer (not shown), which is connected to the digital camera 10 through a host computer interface 34.

In operation, a camera microprocessor 36 receives user inputs 48, such as from a shutter release (not shown), and initiates a capture sequence by signaling a timing generator 38. The timing generator 38 is connected generally to the elements of the digital camera 10, as shown in FIG. 1, for controlling the digital conversion, compression, storage of the image signal and timing the amount of time images are reviewed on the display 24. The camera microprocessor 36 also processes a signal from a photodiode 44 for determining a proper exposure, and accordingly signals an exposure driver 46 for setting the aperture and shutter speed via the aperture/shutter controller 13 and triggers a flash unit 42 (if needed). The image sensor 14 is then driven from the timing generator 38 via a sensor driver 40 to produce the image signal. The user inputs 48 are used to control the operation of the digital camera 10 in a well-known manner.

A motion detector 50, preferably an angular accelerometer or other devices for detecting rotational motion, is connected to the camera processor 36 for detecting motion of the digital camera 10 associated with each image during its display. Images with motion above a threshold are tagged as a “favorite image” as will described in detail hereinbelow. Motion is detected during: (a) displaying images which have already been taken, stored in memory and are being reviewed on the display (review) or (b) immediately after each image capture and the just-captured image is being displayed on the display (preview). In the case of (a) review, camera motion is measured until any of the following occurs: (i) user advances to another image; (ii) the user exits review mode; (iii) the image is displayed more than a predetermined amount of time according to design preference (usually a few seconds). In the case of (b) preview, motion is only recorded during the time in which the captured image is displayed.

Although an angular accelerometer is used in the preferred embodiment, a gyroscope may also be used to detect the angular displacement.

In the present invention, a handheld device is disclosed that displays a plurality of images during which display time one or more images are identified as a favorite image(s) base on the amount and/or type of handheld motion which occurred when the image is displayed. This motion is assumed to correspond to a sharing event. It is further assumed that images that are shared are implicitly of higher value (“favorites”) than other images. The sharing event can be detected by detecting camera displacement at display time (either during preview or review).

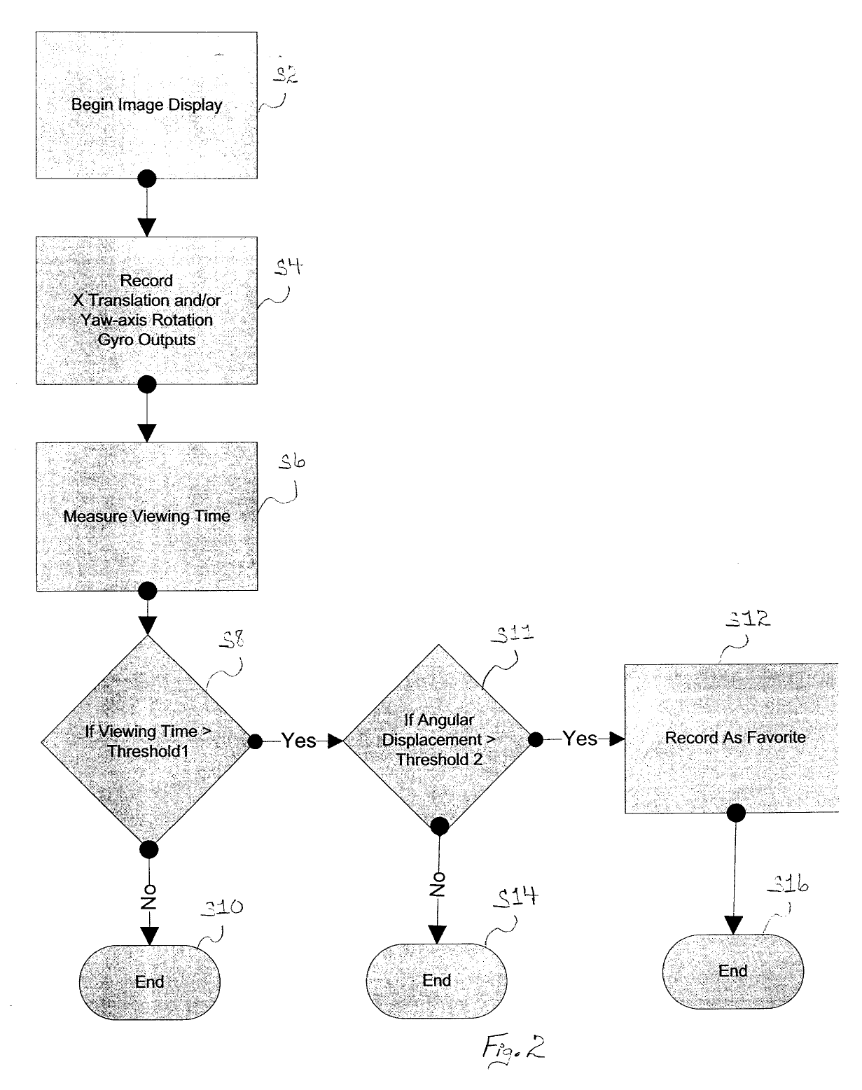

Referring to FIG. 2, there is shown a flow diagram according to a preferred embodiment. In the initial step, the user enters a display mode S2 either automatically after taking a picture (preview) or by means of user action (review or any other similar image review). At this point, the timing generator 38 is started and the Y axis (yaw) and/or x axis gyroscope values are accumulated S4 from the motion detector 50. The viewing time is measured during the time an image is displayed S6.

Next, a decision is made with respect to the viewing time S8. A very short viewing time (viewing time below a predetermined threshold 1, typically a few seconds although more seconds may be required due to design preference) would indicate that the image was not shared or that important and the tagging for this particular image is ended S10. Therefore, it would not be tagged as a favorite. If the viewing time is above a threshold S8, then another decision is made to determine the amount of motion that is consistent with a sharing motion S11 (defined herein as angular displacement). An accelerometer measures the second derivative of angular position. The value that correlates to a sharing operation is angular displacement which is the second integral of the accelerometer output. An angular displacement greater than threshold 2, for example thirty degrees of rotational motion, the image is tagged as a favorite S12. In other words, if both of these conditions are true (the viewing time is above a threshold and the angular displacement is above a threshold), then the image will be automatically tagged as a favorite or of being of high value and thus recorded as metadata and the tagging process for this tagged image is terminated S16. If the angular displacement is not above the threshold 2 (S10), the image is not tagged a favorite and the tagging process for this particular image is terminated S14.

The invention has been described in detail with particular reference to certain preferred embodiments thereof, but it will be understood that variations and modifications can be effected within the spirit and scope of the invention.

### Parts List

10 Camera
12 Lens
13 aperture/shutter controller
14 Image Sensor
16 Analog Signal Processor
18 A/D converter
20 Frame Memory
22 Digital Signal Processor
24 image display
25 LCD controller
26 Data Memory
28 memory card
30 memory card slot
32 memory card interface
34 Host Computer Interface
36 Camera Microprocessor
38 Timing Generator
40 Driver
42 Flash
44 Photodiode
46 Driver
48 User Inputs
50 Motion Detector

1. A handheld device for displaying one or more images, the device comprising:
(a) memory for storing one or more images;
(b) a motion detector for detecting motion of the handheld device; and
(c) a processor for monitoring an amount of motion of the handheld device and for identifying at least one of the images as a favorite image based on the amount of motion of the handheld which occurred when the image is displayed.

2. The handheld device as in claim 1, wherein the processor generates metadata indicating favorite images and associates the metadata with the favorite image.

3. The handheld device as in claim 2, wherein the metadata associated with an image is stored in an image file along with the image data.

4. The handheld device as in claim 1, wherein the processor also monitors time of display of each of the plurality of images that is used for determining whether the image is a favorite image.

5. The handheld device as in claim 1 further comprising an image sensor for capturing the images stored in the memory.

6. The handheld device as in claim 5, wherein the handheld device is a mobile phone.

7. The handheld device as in claim 1, wherein the memory is a removable memory.

8. The handheld device as in claim 1, wherein the motion detector is an accelerometer.

9. The handheld device as in claim 1, wherein the motion detector detects motion primarily in the yaw direction.

10. The handheld device as in claim 1, wherein the motion detector is a gyroscope.

11. The handheld device as in claim 1, wherein the handheld device is a digital camera.
